(19) United States
(12) Patent Application Publication
(10) Pub. No.: US 2013/0346069 A1
(43) Pub. Date: Dec. 26, 2013

(54) METHOD AND APPARATUS FOR IDENTIFYING A MENTIONED PERSON IN A DIALOG

(71) Applicant: Canon Kabushiki Kaisha, Tokyo (JP)

(72) Inventors: Yaohai Huang, Beijing (CN); Rongjun Li, Beijing (CN); Qinan Hu, Beijing (CN)

(21) Appl. No.: 13/916,885

(22) Filed: Jun. 13, 2013

(30) Foreign Application Priority Data
Jun. 15, 2012 (CN) 201210201517.8

(51) Int. Cl. G10L 15/18

(52) U.S. Cl. CPC G10L 15/18
USPC 704/9

(57) ABSTRACT

This application relates to a method and apparatus for identifying a mentioned person in a dialog. A method for identifying a mentioned person in a dialog, comprising: identifying at least one person name entity associated with a mentioned person name which is acquired from the dialog; acquiring a group of candidate identifiers associated with the mentioned person name; acquiring at least one relation feature for each of the candidate identifiers from internal resources and external resources, wherein the relation feature refers to the relation between the candidate identifier and the at least one person name entity; and selecting an identifier from the group of candidate identifiers as the identifier of the mentioned person name based on the at least one relation feature. According to the method and the apparatus of the present invention, a mentioned person can be accurately identified.

### BACKGROUND OF THE INVENTION

1. Field of the Invention

The present technology relates to a method and apparatus for identifying a mentioned person in a dialog, and more specifically, relates to a method and apparatus which are capable of accurately identifying a person name entity of a person that has been mentioned in natural language processing.

2. Description of the Related Art

With the recent development of computer technology, there is a need to automatically identify a person's name in a dialog. Usually, person names in a dialog can be classified into mentioned person name (MPN) and non-mentioned person name (NMPN). Here, the mentioned person name refers to a person's name that has been mentioned during the conversation of the dialog, and the non-mentioned person name refers to a person's name that is in the context of the dialog but is not mentioned during the conversation. To make these terms clearer, FIG. 1 shows an example of a meeting minutes. This meeting minutes is an example of the dialog. As shown in FIG. 1, the meeting minutes includes two attendees, one is David Hill who is a manager of IT department, the other is Alex Bell who is a manager of Local department. Further, during the speaking of Hill, a name of a third person is mentioned, i.e. Lee. In this example, the names “Bell” and “Hill” right before the conversation are called non-mentioned person name (NMPN) because they do not appear in the conversation. The name “Lee” is called mentioned person name (MPN) because this name has been brought up by Hill during the speaking.

As shown in the example of FIG. 1, it is usually easy to recognize the identity of a NMPN. Take “Hill” for example, the term “Hill” which is positioned before the conversation can be recognized easily. Because “Hill” has been listed as an attendee and the list of the attendees can be searched for a match, it is fairly easy to identify “Hill” as “David Hill” who is a manager of IT department. And further, a unique identifier for “David Hill” can be determined from the above information. The identifier here may be, for example, a unique ID assigned to each and every employee of a corporation. On the other hand, it is difficult to recognize the identity of “Lee” because “Lee” is only mentioned by Hill and is not listed as an attendee, and there may be a plurality of people with the name “Lee”.

In the past, there have been technologies for identifying person names. For example, Zeng Hua-jun et al (U.S. Pat. No. 7,685,201B2) have described a technology for person disambiguation using name entity extraction-based clustering, so that different persons having the same name can be clearly distinguished. Name entity extraction locates words (terms) that are within a certain distance of persons' names in the search results. The terms are used in disambiguating search results that correspond to different persons having the same name, such as location information, organization information, career information, and/or partner information. In one example, each person is represented as a vector, and similarity among vectors is calculated based on weighting that corresponds to nearness of the terms to a person, and/or the types of terms. Based on the similarity data, the person vectors that represent the same person are then merged into one cluster, so that each cluster represents (to a high probability) only one distinct person.

Also, BUNESCU et al (US2007/0233656A1) have described a method for the disambiguation of named entities where named entities are disambiguated in search queries and other contexts using a disambiguation scoring model. The scoring model is developed using a knowledge base of articles, including articles about named entities. Various aspects of the knowledge base, including article titles, redirect pages, disambiguation pages, hyperlinks, and categories, are used to develop the scoring model.

However, the prior arts introduced above are not accurately enough in identifying a person that has been mentioned (i.e. a mentioned person). And in many cases, a mentioned person cannot be uniquely identified. There may be still a plurality of identifiers (each of which corresponds to a unique person) after applying the above methods.

### SUMMARY

One of the objects of the present invention is to solve at least one of the problems mentioned above.

According to an embodiment of the present invention, there is provided a method for identifying a mentioned person in a dialog, comprising: identifying at least one person name entity associated with a mentioned person name which is acquired from the dialog; acquiring a group of candidate identifiers associated with the mentioned person name; acquiring at least one relation feature for each of the candidate identifiers from internal resources and external resources, wherein the relation feature refers to the relation between the candidate identifier and the at least one person name entity; and selecting an identifier from the group of candidate identifiers as the identifier of the mentioned person name based on the at least one relation feature. The relation features preferably include at least one of: a rank gap feature, which represents a gap between two persons' ranks; a familiar feature, which represents a familiarity degree between two persons; a history appellation feature, which represents appellations that have been used between two persons; and a context relation feature, which represents two persons' relation in the dialog.

Wherein, the rank gap feature includes at least one of: a feature of title gap, which represents a gap between titles of two persons; and a feature of age gap, which represents a gap between ages of two persons. The familiar feature includes at least one of: a feature of same working group, which represents whether two persons are in the same working group; a feature of same major, which represents whether two persons are of the same major; a feature of new employee, which represents whether a person is a new employee; a feature of discussion frequency, which reflects a frequency of discussion between two persons; and a feature of working station distance, which represents a distance between working stations of two persons. The context relation feature includes at least one of: a feature of same meeting group, which represents whether two persons belong to the same meeting group; a feature of co-joint meeting, which represents whether both of the two persons join a meeting; a feature of seat class gap, which represents a gap between seat classes of two persons, wherein the seats are classified into at least two classes, one is primary seat and the other is secondary seat; and a feature of seat distance, which represents a distance between seats of two persons.

According to a further embodiment of the present invention, there is provided a method for managing meeting minutes, comprising: identifying a mentioned person by using the above method for identifying a mentioned person in a dialog; and embedding information associated with the selected identifier into the mentioned person name in an output text. The relation features preferably include at least one of: a feature of title gap, which represents a gap between titles of two persons; a feature of same working group, which represents whether two persons are in the same working group; and a history appellation feature, which represents appellations that have been used between two persons.

According to a further embodiment of the present invention, there is provided a method for managing a conference, comprising: identifying a mentioned person by using above method for identifying a mentioned person in a dialog; and displaying information associated with the selected identifier on a screen. The relation features preferably include at least one of: a feature of title gap, which represents a gap between titles of two persons; a feature of same working group, which represents whether two persons are in the same working group; a history appellation feature, which represents appellations that have been used between two persons; a feature of seat class gap, which represents a gap between seat classed of two persons; and a feature of seat distance, which represents a distance between seats of two persons.

According to a further embodiment of the present invention, there is provided a method for assisting an instant message, comprising: identifying a mentioned person by using the above method for identifying a mentioned person name in a dialog; and embedding information associated with the selected identifier into the mentioned person name in the instant message. The relation features preferably include at least one of: a feature of title gap, which represents a gap between titles of two persons; a feature of age gap, which represents a gap between ages of two persons; a feature of name category, which represents whether two persons are familiar with each other; a feature of discussion frequency, which reflects a frequency of discussion between two persons; and a history appellation feature, which represents appellations that have been used between two persons.

According to a further embodiment of the present invention, there is provided an apparatus for identifying a mentioned person in a dialog, comprising: unit for identifying at least one person name entity associated with a mentioned person name which is acquired from the dialog; unit for acquiring a group of candidate identifiers associated with the mentioned person name; unit for acquiring at least one relation feature for each of the candidate identifiers from internal resources and external resources, wherein the relation feature refers to the relation between the candidate identifier and the at least one person name entity; and unit for selecting an identifier from the group of candidate identifiers as the identifier of the mentioned person name based on the at least one relation feature.

According to a further embodiment of the present invention, there is provided an apparatus for managing meeting minutes, comprising: unit for identifying a mentioned person by using the above apparatus for identifying a mentioned person in a dialog; and unit for embedding information associated with the selected identifier into the mentioned person name in an output text.

According to a further embodiment of the present invention, there is provided an apparatus for managing a conference, comprising: unit for identifying a mentioned person by using the above apparatus for identifying a mentioned person in a dialog; and unit for displaying information associated with the selected identifier on a screen.

According to a further embodiment of the present invention, there is provided an apparatus for assisting an instant message, comprising: unit for identifying a mentioned person by using the above apparatus for identifying a mentioned person name in a dialog; and unit for embedding information associated with the selected identifier into the mentioned person name in the instant message.

According to the methods and apparatuses of the present invention, a mentioned person name can be accurately identified. In some embodiments of the present invention, the identifier of the mentioned person name may be further embedded into the dialog or the instant message. Thus, people may quickly know whom the mentioned person name refers to.

Further characteristic features and advantages of the present invention will be apparent from the following description with reference to the drawings.

### BRIEF DESCRIPTION OF THE DRAWINGS

FIG. 1 shows an example of a meeting minutes.

FIG. 2 is a flowchart for explaining a method for identifying a mentioned person in a dialog according to one embodiment of the present invention.

FIG. 3 illustrates a flowchart for explaining a method for generating a database according to one embodiment of the present invention.

FIG. 4 is a flowchart for illustrating the step of selecting an identifier from a group of candidate identifiers.

FIG. 5 is an example of an input dialog.

FIG. 6 is an example of an organization chart.

FIG. 7 illustrates a configuration of an apparatus for the managing meeting minutes according to a second embodiment of the present invention.

FIG. 8 shows a flowchart of the processing procedure of an apparatus for managing the meeting minutes according to the second embodiment of the present invention.

FIG. 9 illustrates the result of the integration according to the second embodiment of the present invention.

FIG. 10 illustrates a configuration of an apparatus for managing a conference according to a third embodiment of the present invention.

FIG. 11 shows a flowchart of the processing procedure of an apparatus for managing a conference according to the third embodiment of the present invention.

FIG. 12 illustrates the result of the integration according to the third embodiment of the present invention.

FIG. 13 illustrates a configuration of an apparatus for assisting an instant message according to a fourth embodiment of the present invention.

FIG. 14 shows a flowchart of the processing procedure of an apparatus for assisting an instant message according to the fourth embodiment of the present invention.

FIG. 15 illustrates the result of the integration according to the fourth embodiment of the present invention.

FIG. 16 illustrates a configuration of an apparatus for identifying a mentioned person according to an embodiment of the present invention.

FIG. 17 is a block diagram showing a hardware configuration of a computer system which can implement the embodiments of the present invention.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

FIG. 2 is a flowchart for explaining a method for identifying a mentioned person in a dialog according to one embodiment of the present invention.

As shown in FIG. 2, the method for identifying a mentioned person in a dialog includes at least four steps:
(a) identifying at least one person name entity associated with a mentioned person name which is acquired from the dialog (Step S211);
(b) acquiring a group of candidate identifiers associated with the mentioned person name (Step S212);
(c) acquiring at least one relation feature for each of the candidate identifiers from internal resources and external resources (Step S213), wherein the relation feature refers to the relation between the candidate identifier and the at least one person name entity; and
(d) selecting an identifier from the group of candidate identifiers as the identifier of the mentioned person name based on the at least one relation feature (Step S214).

Next, the above steps of the method for identifying a mentioned person in a dialog will be explained in detail with reference to the drawings.
(a) Firstly, at least one person name entity associated with a mentioned person name which is acquired from the dialog is identified.

The person name entity may be, for example, a speaker who mentions the mentioned person name in the dialog, and/or one or more listeners who are listening to the speaker. In one preferred example, the person name entity may include a speaker and at least one listener.

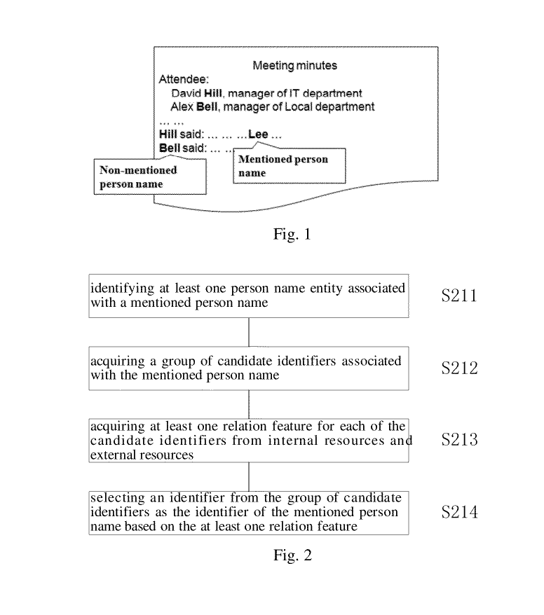

In the meeting minutes as shown in FIG. 1, the person name entity may be “David Hill”, or “Alex Bell”, or both. In a case where there is a plurality of listeners, the person name entity preferably includes the speaker and the listener that has spoken immediately before the speaker or is going to speak immediately after the speaker. The reason for such a configuration is that the listeners that speak immediately before or after the speaker will most likely have a certain relation with the mentioned person name, and such a relation may be helpful in finally identifying the mentioned person name.

The dialog may be stored in a storage device and may be readout and analyzed to acquire the mentioned person name (e.g. in case the dialog is a meeting minutes). The dialog may also be generated and analyzed in real time (e.g. in case the dialog is an instant message or the dialog is generated in real time by an intelligent conference system). The technology of acquiring a mentioned person name from a dialog is well known to one skilled in the art and the description thereof is omitted for concision.
(b) Secondly, a group of candidate identifiers associated with the mentioned person name is acquired.

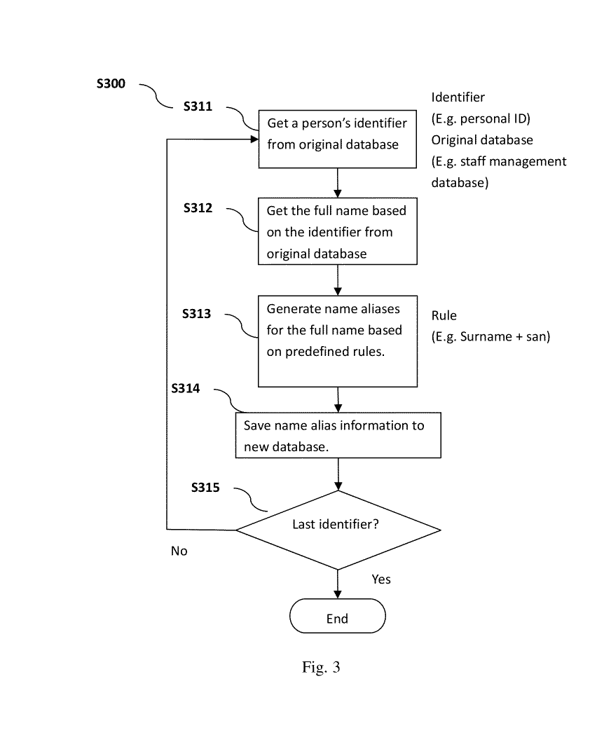

The candidate identifiers may be acquired by, for example, searching for candidate identifiers based on the mentioned person name in a database which at least comprises identifiers and the corresponding person names. Wherein the person names in the database include full names and name aliases, and the name aliases includes at least one of a nickname, a surname, a given name, a middle name, and a combination of a title and at least one of the nickname, surname, given name and middle name. FIG. 3 illustrates a flowchart for explaining a method for generating such a database (S300).

As shown in FIG. 3, a person's identifier (e.g. IDs) is obtained from an original database (Step S311). For example, the original database may be a staff management database that includes staff IDs (as the identifiers) and the corresponding full names. Then, the full name that corresponds to the identifier is also obtained from the original database (Step S312). Next, name aliases for the full name are generated based on predefined rules (Step S313). It should be noted, the rules can be defined manually based on the requirements of the actual application. Further, the rules are language dependent, i.e. different rules may be defined for different languages. Table 1 shows an example of such rules for Japanese. As shown in Table 1, in the case where the language is Japanese, the name aliases for a full name are generated based on the rules listed in the Table 1. In Japanese, a person usually has a surname and a given name. Suffixes such as “san”, “kun” and “chan” may be added. Also, prefixes representing the educational level or the title of the person may be added. In Japanese, Given name may be mentioned directly without any prefix or suffix. Therefore, Given name is defined as a name alias.

TABLE 1
Example of name alias rules

| | |
|---|---|
| Language | Japanese |
| Rules | Surname + san |
| | Given name |
| | Given name + kun |
| | Given name + chan |
| | Educational level + surname |
| | Title + surname |

Next, the generated name aliases are saved in a new database for later usage (Step 314). At last, it is determined whether it is the last identifier, i.e. whether the name aliases have been generated with respect to all the identifiers in the original database. If yes, the processing is ended and the new database is generated. If no, the processing returns to Step S311 and a new identifier is obtained from the original database.
(c) Next, at least one relation feature is acquired for each of the candidate identifiers from internal resources and external resources.

In the present invention, the relation feature refers to the relation between the candidate identifier and the identified person name entity. The internal resources may include at least one of an attendee list, a conference video(s) and a conference photo(s). The external resources may include at least one of text resources and image resources. The examples of text resources are organization charts, email logs, email contacts, resumes and public documents. The example of image resources is figures of working station that shows the position of each employee's desk.

The relation feature may include at least one of the following features: a rank gap feature, a familiar feature, a history appellation feature and a context relation feature. And for example, the familiar feature and the history appellation feature are extracted from the external resources, the rank gap feature is extracted from the external resources and/or the internal resources, the context relation feature is extracted from the internal resources.

The rank gap feature represents a gap between two persons' ranks, wherein the larger the gap is, the more likely the person of the lower rank would address the person of the higher rank with honorary-like title.

The rank gap feature may include at least one of the following features: the feature of title gap and the feature of age gap.

The feature of title gap represents a gap between the titles of two persons. For example, when an ordinary staff is speaking in the dialog, he may use the suffix “kun” when mentioning a colleague that is also an ordinary staff and may use the suffix “san” when mentioning a senior manager or a person of a higher title. In another example, if the ordinary staff mentions, for example, a person of much higher title such as the CEO of the corporation, the suffix “sama” may be used. Therefore, the feature of title gap is helpful in determining the identifier of the mentioned person name.

In one example of the embodiment, the feature of title gap may be obtained by: extracting title information of the candidate identifier and the at least one person name entity from, for example, an organization chart; and calculating the title difference between the candidate identifier and the at least one person name entity based on the title information.

The feature of age gap represents a gap between the ages of two persons. In many countries, an elder person will probably use a nickname or only the given name to address a younger person. In one example of the embodiment, the feature of age gap may be obtained by: extracting age values of the candidate identifier and the at least one person name entity from, for example, an age field of the respective resume; and calculating the age difference between the candidate identifier and the at least one person name entity based on the age values.

The familiar feature represents a familiarity degree between two persons. Generally, the more familiar the two persons are, the more likely they would use nick-like title to address each other. In one example of the embodiment, the familiar feature may include at least one of the following features: a feature of same working group, a feature of same major, a feature of new employee, a feature of discussion frequency and a feature of working station distance.

The feature of same working group represents whether two persons are in the same working group. If two persons are in the same working group, there is high probability that they are familiar with each other and thus nick-like titles might be used. In an example of the embodiment, the feature of same working group may be obtained by: extracting names of the working group for the candidate identifier and the at least one person name entity from, for example, the organization chart, and calculating the feature of same working group based on the comparison of the names of the working group.

The feature of same major represents whether two persons are of the same major. If two persons are of the same major, there is high probability that they are familiar with each other and thus nick-like titles might be used. In an example of the embodiment, the feature of same major may be obtained by: extracting majors of the candidate identifier and the at least one person name entity from, for example, the organization chart and calculating the feature of same major based on the comparison of the majors.

The feature of new employee represents whether a person is a new employee. If a person is a new employee, he might be not familiar with other employees yet. And the nick-like titles might not be used by either the new employee or other employees when they mention each other. In an example of the embodiment, the feature of new employee may be obtained by: calculating joining period of the candidate identifier (i.e. for how long the candidate identifier has been joined into the organization chart) according to the transition of the organization chart and calculating the feature of new employee based on the comparison of the lifetime with a predetermined threshold (i.e. the first threshold). This first threshold may be, for example, 3 or 6 months or more.

The feature of discussion frequency reflects a frequency of discussion between two persons. If two persons frequently discuss together, they may have been quite familiar with each other. The nick-like titles may be used to address each other. In an example of the embodiment, the feature of discussion frequency can be obtained by: counting a communication frequency between the candidate identifier and the at least one person name entity from, for example an email log, and calculating the feature of discussion frequency based on the comparison of the communication frequency with a predetermined threshold (i.e. the second threshold). For example, the second threshold may be defined as 5 times which means that if two persons have been communicated with each other for 5 times or more times, they are probably familiar with each other to the degree of using nick-like titles.

The feature of working station distance represents a distance between the working stations of two persons. If the working positions of two persons are near, they may often see or run into each other on the working days and thus may familiar with each other. Therefore, the nick-like titles might also be used to address each other. In an example of the embodiment, the feature of working station distance can be obtained by: obtaining working positions of the candidate identifier and the at least one person name entity from, for example, the figure of working station, and calculating the feature of working station distance based on the working positions. The figure of working station shows the working positions (e.g. positions of the desks) of the employees.

Further, the history appellation feature represents the appellations that have been used between two persons. In an example of the embodiment, the history appellation feature is obtained by: extracting an appellation between the candidate identifier and the at least one person name entity in history from email logs.

Further, the context relation feature represents two persons' relation in the dialog. In the embodiment of the present invention, the context of the dialog is taken into account when identifying a mentioned person name. In case the dialog is happened during a meeting, the context relation feature may include at least one of the following: a feature of same meeting group, a feature of co-joint meeting, a feature of seat class gap and a feature of seat distance.

The feature of same meeting group represents whether two persons belong to the same meeting group. If two persons belong to the same meeting group, they may use nick-like titles to address each other. In an example of the embodiment, the feature of same meeting group is obtained by: extracting the names of the meeting group for the candidate identifier and the at least one person name entity from, for example, an attendee list, and calculating the feature of same meeting group based on the comparison of the names of the meeting group. If the names of the meeting group are the same, the candidate identifier and the person name identity are in the same meeting group.

The feature of co-joint meeting represents whether both of the two persons join a meeting. If two persons both join a meeting, they may use nick-like titles to address each other during the conversation of the meeting. In an example of the embodiment, the feature of co-joint meeting can be obtained by: comparing the name of the candidate identifier with, for example. an attendee list, and calculating the feature of co-joint meeting based on the comparison result. If the name of a candidate identifier is in the attendee list, the mentioned person and the speaker have both joined the meeting. There is no need to search for the speaker's name in the attendee list because it is obvious that the speaker who speaks at the meeting must have joined the meeting, no matter his name is in the attendee list or not.

The feature of seat class gap represents a gap between seat classes of two persons. In many meetings, the seats are classified into two or more classes. In the case of two classes, one class is primary seat and the other is secondary seat. The primary seat is usually prepared for persons of highest title or rank, and the secondary seat is usually prepared for other persons. For example, if the meeting table is rectangle, there may be only one primary seat and a plurality of secondary seats. In this case the primary seat may be positioned at one of the short-sides of the table and the secondary seats are positioned alongside both long-sides of the table. In an example of the embodiment, the feature of seat class gap can be obtained by: extracting seat classes of the candidate identifier and the at least one person name entity from, for example, a conference video or a conference photo, and calculating the feature of seat class gap based on the extracted seat classes.

The feature of seat distance represents a distance between the seats of two persons. If two persons are seated close, they may use nick-like titles to address each other. In an example of the embodiment, the feature of seat distance can be obtained by: extracting seat positions of the candidate identifier and the at least one person name entity from, for example, a conference video or a conference photo, and calculating the feature of seat distance based on the extracted seat positions.

The relation features of the present invention have been briefly introduced above. However, one skilled in the art should understand that the relation features should not be limited to these specific features described above. Actually, any feature that reflects the relation of two persons may be used as a relation feature.
(d) Selecting an identifier from the group of candidate identifiers as the identifier of the mentioned person name based on the at least one relation feature (Step S214).

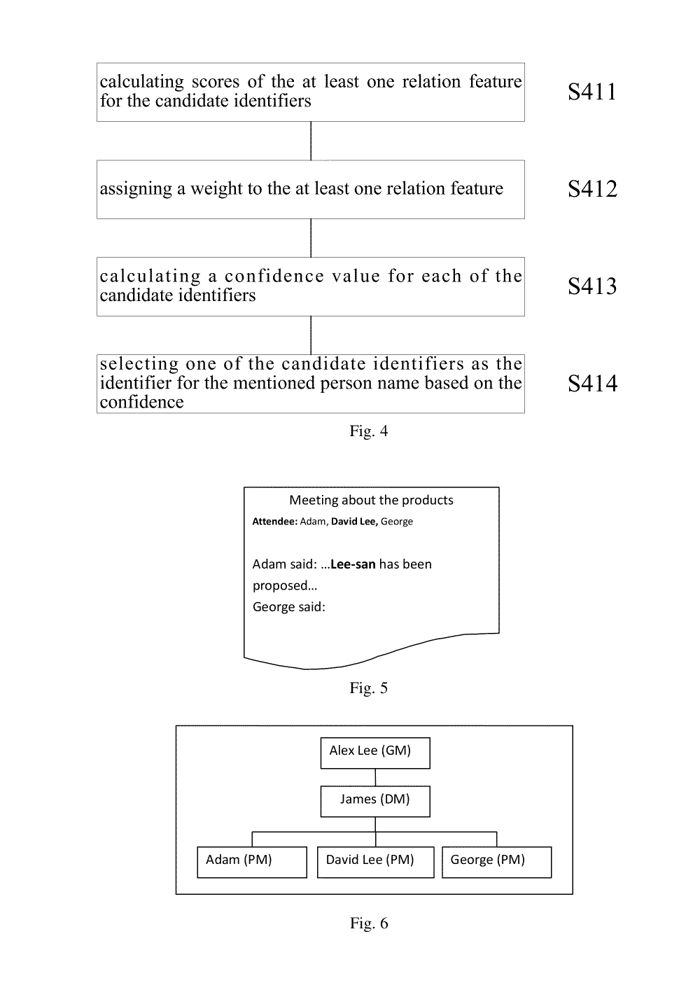

FIG. 4 is a flowchart for illustrating the step of selecting an identifier from a group of candidate identifiers. As shown in FIG. 4, a score of each relation feature is calculated (Step S411), and a weight is assigned to each relation feature (Step S412). Thus, each relation feature is now associated with a score and a weight. Then, a confidence value is calculated for each of the candidate identifiers based on the scores and the weights of the relation features (Step S413). Finally, one of the candidate identifiers is selected as the identifier for the mentioned person name based on the confidence (Step S414). It should be note that the selection rules can be determined based on the actual applications. In one example of the embodiment, the candidate identifier with the highest confidence value is selected as the identifier for the mentioned person name. And in another example of the embodiment, the candidate identifier with the lowest confidence value is selected as the identifier for the mentioned person name. Also, the confidence value is a term customarily used by one skilled in the art. The confidence value may be calculated in various ways. For example, in one example, the confidence value may be represented by the weighted sum of the scores of the relation features.

The weight for a relation feature may be assigned manually or automatically. For example, in one embodiment, the weight is assigned according to scenarios of the dialog which may be extracted from context features of the dialog. The context features may be such as a title of the dialog, a topic of the dialog, a language style of the dialog, the dress style of the attendees or any other feature that is helpful in determining the scenario of the dialog. In one embodiment of the present invention, two scenarios are defined, one is “office” and the other is “home”.

According to the context features, if the title of the dialog includes term “meeting” or “conference” or the like, this scenario is probably “office”. Thus, the scenario is determined to be “office”. Otherwise, the scenario is determined to be “home”.

If the topic of the dialog concerns “products” or “sales” or the like, this scenario is probably “office”. Thus the scenario is determined to be “office”. Otherwise, the scenario is determined to be “home”.

If the language style of the dialog is quite formal, the scenario may be determined to be “office”. Otherwise, the scenario can be determined to be “home”.

If the dress style of the attendees is formal, for example people in the conference video or photo dress formally, this scenario may be determined as “office”. Otherwise, the scenario can be determined to be “home”.

As described above with reference to FIGS. 2-4, the present invention takes account of relation features during the MPN recognition process to improve the accuracy of MPN recognition. More detailed embodiments and explanations will be given below in connection with FIG. 5.

Before analyzing the embodiment in FIG. 5, the relation features are defined as follows.
1. The feature of title gap is defined as

Rf₁=TI(arg₁)−TI(arg₂),

where each of arg₁ and arg₂ represent an identifier, and TI(x) is a function to acquire the title of x from, for example, the organization chart. It should be understand that the “x” here only broadly represents an argument. For example, x could be arg₁ or arg₂, or any other appropriate identifier. The subsequent relation features will also use “x” which should be understood similarly.
2. The feature of age gap is defined as

Rf₂=AG(arg₁)−AG(arg₂),

where AG(x) is a function to acquire the age of x from, for example, the age field of the resume of x.
3. The feature of same working group is defined as

$${Rf}_{3} = \{ \begin{matrix}1 & if GP ( {arg}_{1} ) = GP ( {arg}_{2} ) \\ 0 & else\end{matrix}$$

where GP(x) is a function to acquire the name of working group of x from, for example, the organization chart.
4. The feature of same major is defined as

$${Rf}_{4} = \{ \begin{matrix}1 & if MJ ( {arg}_{1} ) = MJ ( {arg}_{2} ) \\ 0 & else\end{matrix}$$

where the function MJ (x) is a function to acquire the major of x from, for example, the organization chart.
5. The feature of new employee is defined as

$${Rf}_{5} = \{ \begin{matrix}1 & if NE ( {arg}_{1} ) \leq {TH}_{1} \\ 0 & else\end{matrix}$$

where NE(x) is a function to acquire the joining period of x from, for example, the organization chart, and TH₁ is a predetermined threshold (the first threshold) value.
6. The feature of discussion frequency is defined as

$${Rf}_{6} = \{ \begin{matrix}1 & if DF ( {arg}_{1} \& {arg}_{2} ) \leq {TH}_{2} \\ 0 & else\end{matrix}$$

where DF (arg₁&arg₂) is a function to acquire the discussion frequency between arg₁ and arg₂ from, for example, the email logs, and TH₂ is a predetermined threshold (the second threshold) value.

7. The feature of working station distance is defined as

Rf₇=PS(arg₁)−PS(arg₂)

where PS(x) is a function to acquire the working position of x from, for example, the figure of working station.
8. The history appellation feature is defined as

Rf₈=Appe, if AP(arg₁&arg₂)=Appe

where AP(arg₁&arg₂) is a function to determine whether there is an appellation between arg₁ and arg₂ from, for example, the email logs. Appe represents the determined appellation.
9. The feature of same meeting group is defined as

$${Rf}_{9} = \{ \begin{matrix}1 & if MGP ( {arg}_{1} ) = MGP ( {arg}_{2} ) \\ 0 & else\end{matrix}$$

where MGP(x) is a function to acquire the name of the meeting group of x from, for example, the attendee list.
10. The feature of co-joint meeting is defined as

$${Rf}_{10} = \{ \begin{matrix}1 & if CJ ( {arg}_{1} ) = true \\ 0 & else\end{matrix}$$

where CJ(x) is a function to acquire the comparison result of x and the attendee list. If x is in the attendee list, the value of CJ(x) is true. Otherwise, the value of CJ(x) is false.
11. The feature of seat class gap is defined as

Rf₁₁=SC(arg₁)−SC(arg₂)

where SC(x) is a function to acquire the seat class of x from, for example, a conference video or a conference photo.
12. The feature of seat distance is defined as

Rf₁₂=PS(arg₁)−PS(arg₂)

where PS(x) is a function to acquire the seat position of x from, for example, a conference video or a conference photo.

An example of definition of the respective relation features are described above. It should be noted, however, the definition is not limited as above. One skilled in the art will adopt other kinds of definitions with the teaching and suggestion of the present invention.

### (First Embodiment)

FIG. 5 shows an input dialog. It can be seen that the name “Lee-san” is mentioned by speaker Adam.

Firstly, it is recognized that the person name “Lee-san” has been mentioned, and the person name entity associated with the mentioned person name are identified from the dialog:
Speaker: Adam
Listener (Next Speaker): George.

Next, a group of candidate identifiers are acquired by searching for the mentioned person name in a name alias database. A portion of the name alias database is given as table.2

TABLE 2
Name alias database

| Name | | Full | |
|---|---|---|---|
| Aliases | Identifier | Name | Department |
| Lee san | ID 001 | David Lee | D1 |
| (surname + san) | | | |
| David | | | |
| (given name) | | | |
| Lee san | ID 002 | Alex Lee | D2 |
| (surname + san) | | | |
| Lee sama | | | |
| (surname + sama) | | | |

According to the name alias database shown in the above table 2, two candidate identifiers are found:

Candidate identifier: David Lee (ID 001, which is the identifier for the mentioned person name)

Candidate identifier: Alex Lee (ID 002)

Next, the relation features are extracted for each of the candidate identifiers. In this embodiment, the relation features are the feature of title gap and the feature of co-joint meeting.

The feature of title gap is consisted of the following sub-features:
(a) Rf₁₋₁: the feature of title gap between speaker and candidate identifiers.
(b) Rf₁₋₂: the feature of title gap between listener and candidate identifiers.
(c) Rf₁₋₃: the feature of title gap between speaker and listener.

FIG. 6 shows an example of an organization chart. According to the organization chart, the following title information can be obtained, and the feature of title gap may be obtained based on the title information.

Title information:

Title of David Lee is Project Manager;

Title of Alex Lee is General Manager;

Title of Adam is Project Manager;

Title of George is Project Manager.

The relation features for the candidate identifier of David Lee (ID 001) are:

Rf₁₋₁(Adam, David.Lee) = 0
Rf₁₋₂(George, David.Lee) = 0
Rf₁₋₃(Adam, George) = 0
Rf₁₀(David.Lee) = 1

The relation features for the candidate identifier of Alex Lee (ID 002) are:

Rf₁₋₁(Adam, Alex.Lee) = 2
Rf₁₋₂(George, Alex.Lee) = 2
Rf₁₋₃(Adam, George) = 0
Rf₁₀(Alex.Lee) = 0

Here, it is assumed that Alex Lee has not joined the meeting, and David Lee has joined the meeting. Therefore, in the above relation features, the feature of co-joint meeting Rf₁₀(David.Lee)=1, while Rf₁₀(Alex.Lee)=0.

The scenario of the dialog can be determined from the title “meeting about the products”. Obviously, this dialog is most probably taken place in the office. Thus, the scenario of the dialog may be determined as “office”.

Based on the scenario “office”, weights can be assigned to each relation feature. Table 3 shows an exemplary assignment.

TABLE 3

| Scenario | Feature of title gap (Rf₁) | Feature of co-joint meeting (Rf₁₀) |
|---|---|---|
| Office | 0.5 | 1 |

As shown in Table 3, the weight assigned to the feature of title gap is 0.5, and the weight assigned to the feature of co-joint meeting is 1.

Table 4 shows rules for classifying the candidate identifiers. The rules given in Table 4 are only an example, and one skilled in the art may use other rules or even a classification model other than the rule-based classification described herein.

TABLE 4

| Relation Feature | Scenario (Office) |
|---|---|
| Rf₁₋₁ < 2 | Surname + san |
| Rf₁₋₁ ≧ 2 | Surname + sama |
| Rf₁-₂ < 2 | Surname + san |
| Rf₁-₂ ≧ 2 | Surname + sama |
| Rf₁-₃ < 2 | Surname + san |
| Rf₁-₃ ≧ 2 | Surname + sama |
| Rf₁₀ = 1 | Surname + san |
| Rf₁₀ = 0 | Given name |

Because the mentioned person name “Lee-san” complies with the rule “Surname+san”, the scores for each relation feature of David Lee are as following table 5:

TABLE 5

| | Classification | |
|---|---|---|
| Relation feature | result | score |
| Rf₁₋₁ = 0 | Surname + san | 1 |
| Rf₁₋₂ = 0 | Surname + san | 1 |
| Rf₁₋₃ = 0 | Surname + san | 1 |
| Rf₁₀ = 1 | Surname + san | 1 |

Therefore, according to the scores of the relation features and the corresponding weights, a confidence value can be calculated:

Confidence value for David Lee: 3×0.5+1×1=2.5

The scores for each relation feature of Alex Lee are as following table 6:

TABLE 6

| Relation feature | Classification result | score |
|---|---|---|
| Rf₁₋₁ = 2 | Surname + sama | 0 |
| Rf₁₋₂ = 2 | Surname + sama | 0 |
| Rf₁₋₃ = 0 | Surname + san | 1 |
| Rf₁₀ = 0 | Given name | 0 |

Therefore, according to the scores of the relation features and the corresponding weights, a confidence value can be calculated:

Confidence value for Alex Lee: 1×0.5+0×1=0.5

According to the confidence value, the larger one is selected as the identifier for the mentioned person name “Lee-san”. Therefore, “Lee-san” is identified as referring to “David Lee” whose ID is 001.

In the above embodiment, the name alias database can be generated from an original database. The original database may only comprise the identifiers, the corresponding full names and the departments, as shown in Table 7.

TABLE 7

| Identifier | Full Name | Department |
|---|---|---|
| ID 001 | David Lee | D1 |
| ID 002 | Alex Lee | D2 |

According to the full names in the original database, various name aliases may be generated for each full name based on predefined rules. One example of such predefined rules is shown in Table 8.

TABLE 8

| | |
|---|---|
| Language | Japanese |
| Rules | Surname + san |
| | Surname + sama |
| | Given name |
| | Given name + kun |
| | Given name + chan |
| | Educational level + surname |
| | Title + surname |

As shown in Table 8, in case the language is Japanese, various prefixes and suffixes can be added to the surname/given name. For David Lee, the name aliases may be Lee-san, Lee-sama, David, David kun, David chan etc. For Alex Lee, the name aliases may be Lee-san, Lee-sama, Alex, Alex kun, Alex chan etc.

FIG. 16 illustrates a configuration of an apparatus for identifying a mentioned person in a dialog according to the method described above.

Specifically, the apparatus in FIG. 16 includes an identifying unit 1610, a candidate acquiring unit 1620, a relation feature acquiring unit 1630 and a selecting unit 1640.

The identifying unit 1610 receives the input dialog, identifies a mentioned person name from the dialog, and then identifies at least one person name entity that is associated with the mentioned person name from the input dialog. As described above, the mentioned person name can be acquired from the dialog based on the prior art that is well known to one skilled in the art. The identified person name entity is then transmitted to the candidate acquiring unit 1620. In another embodiment, the identifying unit 1610 does not identify the mentioned person name. The mentioned person name may be identified by another unit or device and may be input together with the dialog into the identifying unit 1610.

The candidate acquiring unit 1620 receives the person name entity from the identifying unit 1610, and acquires a group of candidate identifiers associated with the mentioned person name by, for example, searching for candidate identifiers based on the mentioned person name in a database as described above. The group of candidate identifiers is then transmitted to the relation feature acquiring unit 1630 and the selecting unit 1640.

The relation feature acquiring unit 1630 receives the group of candidate identifiers from the candidate acquiring unit 1620, and acquires at least one relation feature for each of the candidate identifiers from internal resources and external resources. The acquired relation feature(s) is then transmitted to the selecting unit 1640.

The selecting unit 1640 receives the group of candidate identifiers from the candidate acquiring unit 1620 and the relation feature(s) from the relation feature acquiring unit 1630, and selects an identifier from the group of candidate identifiers as the identifier of the mentioned person name based on the relation feature(s).

### (Second Embodiment)

The above method or apparatus for identifying a mentioned person in a dialog may be applied to an apparatus for managing meeting minutes.

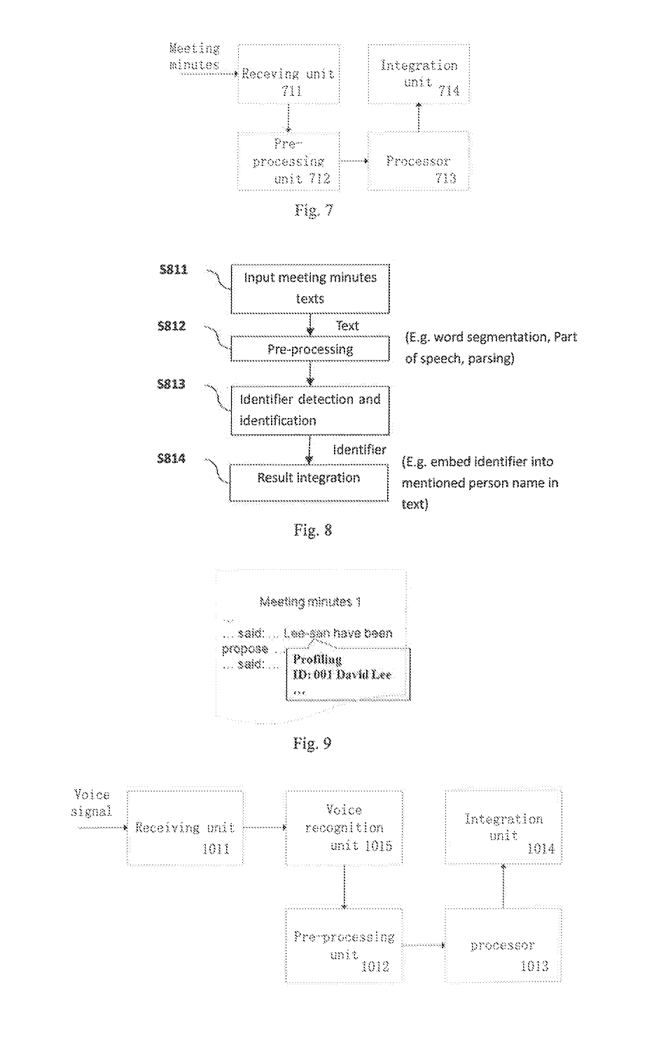

FIG. 7 illustrates a configuration of an apparatus for managing the meeting minutes according to a second embodiment of the present invention.

As shown in FIG. 7, the apparatus for managing the meeting minutes comprises a receiving unit 711, a pre-processing unit 712, a processor 713 and an integration unit 714.

The receiving unit 711 receives meeting minutes from outside and transmits the meeting minutes to the pre-processing unit 712.

The pre-processing unit 712 will pre-process the meeting minutes, for example using word segmentation, POS (Part of Speech) tagger and parser to process the meeting minutes. Such a pre-processing has been widely used during the pre-processing of a natural language processing and is well known to one skilled in the art. Therefore, the detail description of the pre-processing is omitted for concision.

The processor 713 detects the mentioned person name in the texts output by the pre-processing unit 712, identify the mentioned person name based on the method or apparatus described above, and acquire the identifier of the mentioned person name. During the process of identifying the mentioned person name, following relation features are preferred: the feature of title gap, the feature of same working group, the history appellation feature.

The integration unit 714 receives the identifier and embeds it into the mentioned person name in text.

The processing procedure of the apparatus for managing the meeting minutes is shown in FIG. 8. The process includes the following steps:

In step S811, the meeting minutes are received by the receiving unit 711;

In step S812, the pre-processing unit 712 performs pre-processing on the meeting minutes from the receiving unit 711, thus the information, such as word segmentation and POS tagging and parsing of the meeting minutes, is acquired;

In step S813, the processor 713 detects the mentioned person name in the text output by the pre-processing unit 712, identifies the mentioned person name based on the method or apparatus described above, and obtain the identifier of the mentioned person name; and

In step S814, the integration unit 714 embeds the identifier from the processor 713 into the mentioned person name in text.

The result of the integration is illustrated in FIG. 9. As shown in FIG. 9, the identifier is embedded into the mentioned person name, and the ID and full name are shown in the embedded text.

### (Third Embodiment)

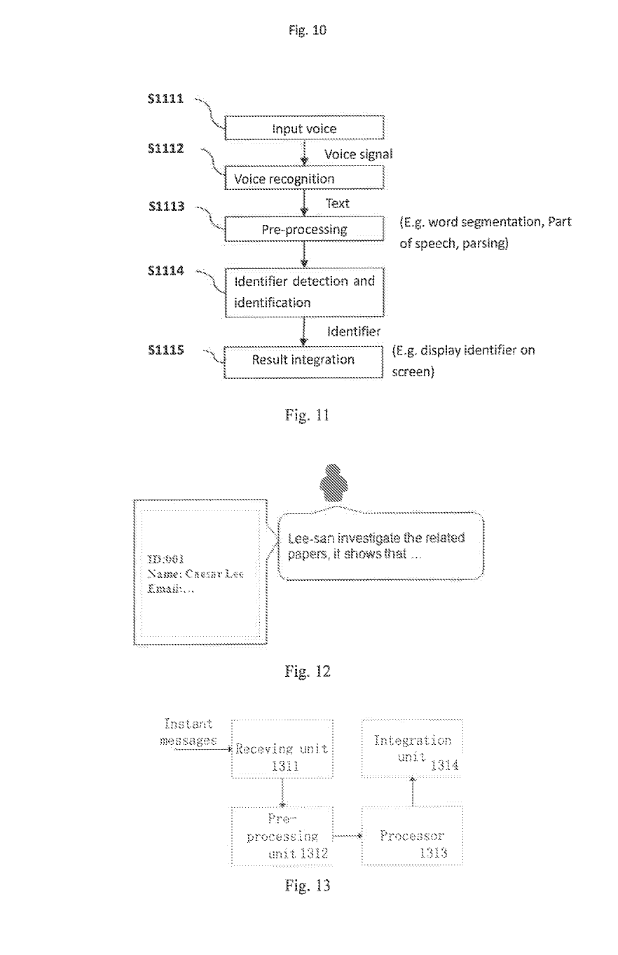

In a further embodiment, the method or apparatus for identifying the mentioned person name can also be applied to an apparatus for managing a conference. FIG. 10 illustrates a configuration of an apparatus for managing a conference according to a third embodiment of the present invention.

As shown in FIG. 10, the apparatus for managing a conference includes a receiving unit 1011, a voice recognition unit 1015, a pre-processing unit 1012, a processor 1013 and an integration unit 1014.

The receiving unit 1011 receives a voice signal from outside and forwards it to the voice recognition unit 1015. The voice signal may be generated, for example, by a microphone or other devices that capture the voice of a speaker.

The voice recognition unit 1015 performs voice recognition to transform the voice into texts, and the texts are transmitted to the pre-processing unit 1012.

The pre-processing unit 1012 performs pre-processing on the texts from the voice recognition unit 1015 to acquire the information, such as word segmentation and POS tagging and parsing of the texts, and transmits the information to the processor 1013.

The processor 1013 detects a mentioned person name, identifies the mentioned person name based on the method or apparatus described above, and acquires the identifier of the mentioned person name. In the case of managing a conference, the following relation features are preferred: the feature of title gap, the feature of same working group, the history appellation feature, the feature of seat class gap and the feature of seat distance.

The integration unit 1014 displays the identifier on a screen.

The processing procedure of the apparatus for managing a conference is shown in FIG. 11. The process includes the following steps:

In step S1111, the voice signal of a speaker is received by the receiving unit 1011.

In step S1112, the voice signal is transformed into texts via the voice recognition of the voice recognition unit 1015.

In step S1113, the information, such as word segmentation and POS tagging and parsing of the texts, is acquired via the pre-processing unit 1012.

In step S1114, a mentioned person name in the texts is detected by using the information, such as word segmentation and POS tagging and parsing of the texts, and this mentioned person name is identified based on the method or apparatus described above. Thus the identifier of the mentioned person name is acquired.

In step S1115, the identifier of the mentioned person name is displayed on a screen.

The result of the integration is illustrated in FIG. 12. As shown in FIG. 12, the ID, full name and email address of the mentioned person name are all displayed on the screen.

### (Fourth Embodiment)

In a still further embodiment, the method or apparatus for identifying the mentioned person name can also be applied to an apparatus for assisting an instant message.

FIG. 13 illustrates a configuration of an apparatus for assisting an instant message according to a fourth embodiment of the present invention.

As shown in FIG. 13, the apparatus for assisting an instant message includes a receiving unit 1311, a pre-processing unit 1312, a processor 1313 and an integration unit 1314.

The receiving unit 1311 receives instant messages and forwards them to the pre-processing unit 1312.

The pre-processing unit 1312 performs pre-processing on the instant messages from the receiving unit 1311 to acquire the information, such as word segmentation and POS tagging and parsing of the instant messages, and transmits the information to the processor 1313.

The processor 1313 detects a mentioned person name, identifies the mentioned person name based on the method or apparatus described above, and acquires the identifier of the mentioned person name. In the case of assisting an instant message, the following relation features are preferred: the feature of title gap, the feature of age gap, the feature of discussion frequency, the history appellation feature and the feature of name category, which represents whether two persons are familiar with each other.

In the case of assisting the instant message, the feature of name category can be defined as

$${Rf}_{13} = \{ \begin{matrix}1 & if CN ( {arg}_{1} ) ∈ FE \\ 0 & else\end{matrix}$$

where CN(arg₁) is a function for obtaining the name of the category that the contact arg₁ of the instant message belongs to. For example, the categories may include friend, family, classmate and stranger. FE is a category set in which a name of a category can show that the two persons are familiar with each other. The FE may include friend, family, classmate, etc.

In the case of assisting the instant message, the feature of name category can be obtained by: extracting the name category of the candidate identifier from the instant messages and then comparing the extracted name category with the predetermined familiar name category (i.e. the above mentioned FE) to decide whether the two persons are familiar with each other.

In the case of assisting the instant message, the feature of title gap is obtained by: extracting title information of the candidate identifier and the at least one person name entity from remark information of instant messages; and calculating the title difference between the candidate identifier and the at least one person name entity based on the title information.

In the case of assisting the instant message, the feature of age gap is obtained by: extracting age values of the candidate identifier and the at least one person name entity from the remark information of instant messages, and calculating the age difference between the candidate identifier and the at least one person name entity based on the extracted age values.

In the case of assisting the instant message, the feature of discussion frequency is obtained by: counting a communication frequency between the candidate identifier and the at least one person name entity from instant messages, and calculating the feature of discussion frequency based on the comparison of the communication frequency with a predetermined threshold.

In the case of assisting the instant message, the history appellation feature is obtained by: extracting an appellation between the candidate identifier and the at least one person name entity in history from instant messages.

The integration unit 1314 embeds the identifier (ID, email address, phone number, etc.) into the mentioned person name in the instant message text.

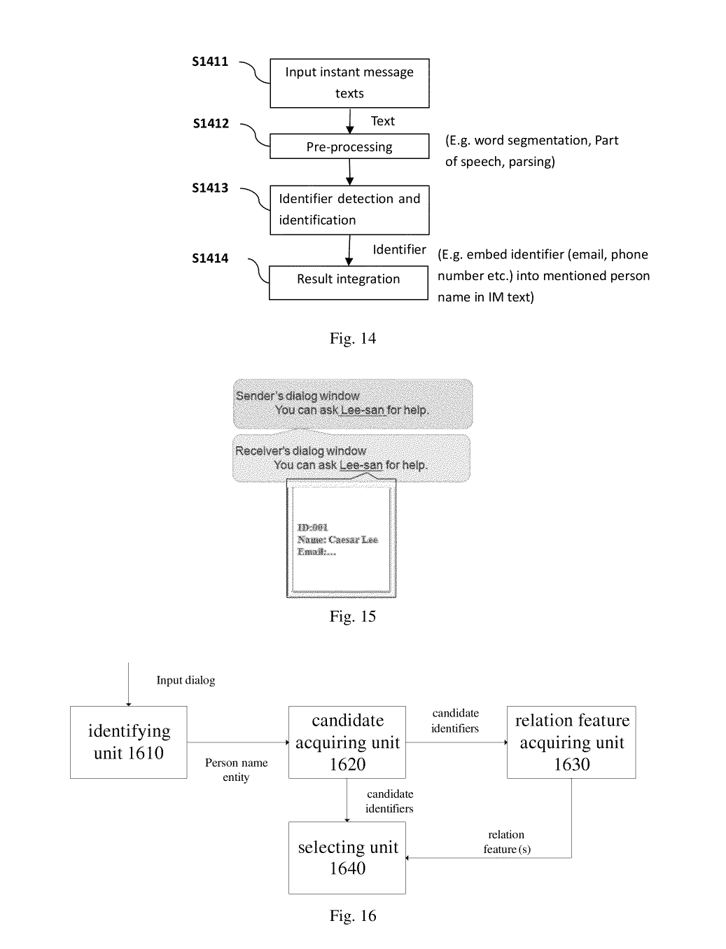

The processing procedure of the apparatus for assisting an instant message is shown in FIG. 14. The process includes the following steps:

In step S1411, the instant messages are received by the receiving unit 1311.

In step S1412, the instant messages are preprocessed by the pre-processing unit 1312 to acquire the information, such as word segmentation and POS tagging and parsing of the instant messages.

In step S1413, by the processor 1313, a mentioned person name in the instant messages is detected by using the information, such as word segmentation and POS tagging and parsing of the instant messages, and this mentioned person name is identified based on the method or apparatus described above. Thus the identifier of the mentioned person name is acquired.

In step S1414, the identifier of the mentioned person name is embedded into the mentioned person name in the instant message text by the integration unit 1314.

The result of the integration is illustrated in FIG. 15. As shown in FIG. 15, the identifier of the mentioned person name (ID, full name, email address, etc.) is displayed in a pop-up window at the receiver's side.

The above apparatuses in the embodiments are only examples for illustration. The method and apparatus of the present invention may be applied to many other situations. Since the relation features are used in the present invention to identify a mentioned person name in a dialog, the result of the identification is more accurate.

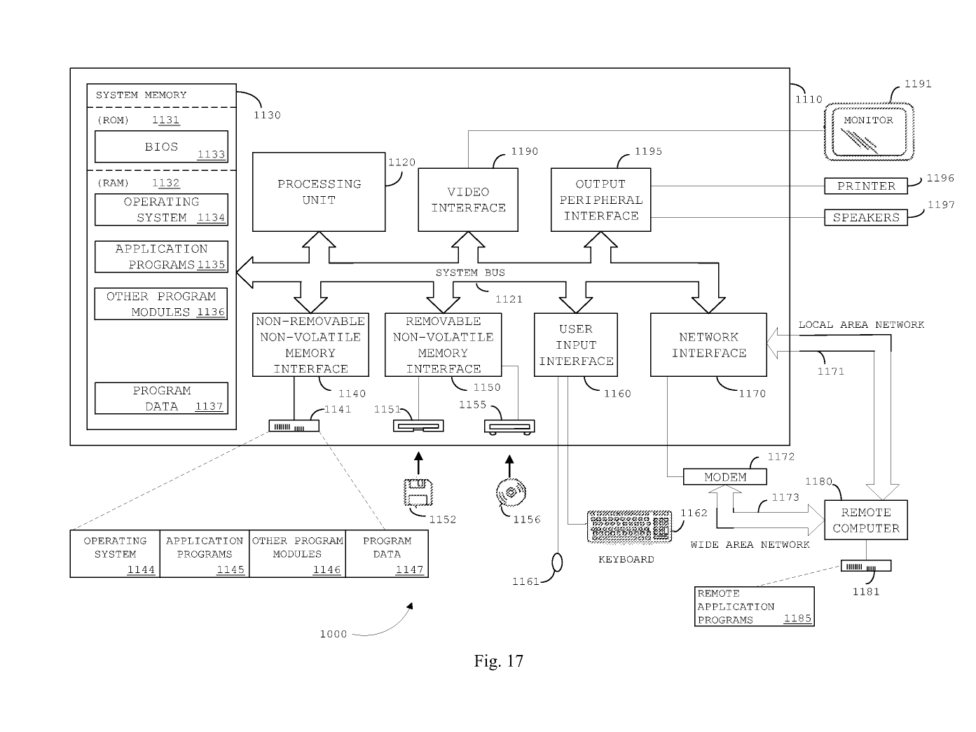

FIG. 17 is a block diagram showing a hardware configuration of a computer system 1000 which can implement the embodiments of the present invention.

As shown in FIG. 17, the computer system comprises a computer 1110. The computer 1110 comprises a processing unit 1120, a system memory 1130, non-removable non-volatile memory interface 1140, removable non-volatile memory interface 1150, user input interface 1160, network interface 1170, video interface 1190 and output peripheral interface 1195, which are connected via a system bus 1121.

The system memory 1130 comprises ROM (read-only memory) 1131 and RAM (random access memory) 1132. A BIOS (basic input output system) 1133 resides in the ROM 1131. An operating system 1134, application programs 1135, other program modules 1136 and some program data 1137 reside in the RAM 1132.

A non-removable non-volatile memory 1141, such as a hard disk, is connected to the non-removable non-volatile memory interface 1140. The non-removable non-volatile memory 1141 can store an operating system 1144, application programs 1145, other program modules 1146 and some program data 1147, for example.

Removable non-volatile memories, such as a floppy drive 1151 and a CD-ROM drive 1155, are connected to the removable non-volatile memory interface 1150. For example, a floppy disk 1152 can be inserted into the floppy drive 1151, and a CD (compact disk) 1156 can be inserted into the CD-ROM drive 1155.

Input devices, such a microphone 1161 and a keyboard 1162, are connected to the user input interface 1160.

The computer 1110 can be connected to a remote computer 1180 by the network interface 1170. For example, the network interface 1170 can be connected to the remote computer 1180 via a local area network 1171. Alternatively, the network interface 1170 can be connected to a modem (modulator-demodulator) 1172, and the modem 1172 is connected to the remote computer 1180 via a wide area network 1173.

The remote computer 1180 may comprise a memory 1181, such as a hard disk, which stores remote application programs 1185.

The video interface 1190 is connected to a monitor 1191.

The output peripheral interface 1195 is connected to a printer 1196 and speakers 1197.

The computer system shown in FIG. 17 is merely illustrative and is in no way intended to limit the invention, its application, or uses.

The computer system shown in FIG. 17 may be implemented to any of the embodiments, either as a stand-alone computer, or as a processing system in an apparatus, possibly with one or more unnecessary components removed or with one or more additional components added.

It is possible to carry out the method and apparatus of the present invention in many ways. For example, it is possible to carry out the method and apparatus of the present invention through software, hardware, firmware or any combination thereof. The above described order of the steps for the method is only intended to be illustrative, and the steps of the method of the present invention are not limited to the above specifically described order unless otherwise specifically stated. Besides, in some embodiments, the present invention may also be embodied as programs recorded in recording medium, including machine-readable instructions for implementing the method according to the present invention. Thus, the present invention also covers the recording medium which stores the program for implementing the method according to the present invention.

Although some specific embodiments of the present invention have been demonstrated in detail with examples, it should be understood by a person skilled in the art that the above examples are only intended to be illustrative but not to limit the scope of the present invention. It should be understood by a person skilled in the art that the above embodiments can be modified without departing from the scope and spirit of the present invention. The scope of the present invention is defined by the attached claims. While the invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Chinese Patent Application No. 2012-10201517.8, filed in Jun. 15, 2012, which is hereby incorporated by reference herein in its entirety.

1. A method for identifying a mentioned person in a dialog, comprising:
identifying at least one person name entity associated with a mentioned person name which is acquired from the dialog;
acquiring a group of candidate identifiers associated with the mentioned person name;
acquiring at least one relation feature for each of the candidate identifiers from internal resources and external resources, wherein the relation feature refers to the relation between the candidate identifier and the at least one person name entity; and
selecting an identifier from the group of candidate identifiers as the identifier of the mentioned person name based on the at least one relation feature.

2. The method of claim 1, wherein the person name entity includes
a speaker who mentions the mentioned person name in the dialog, and/or
at least one listener who listens to the speaker.

3. The method of claim 1, wherein the step of acquiring the group of candidate identifiers includes searching for the candidate identifiers based on the mentioned person name in a database which at least comprises identifiers and corresponding person names,
wherein the person names in the database include full names and name aliases, and
wherein the name aliases includes at least one of a nickname, a surname, a given name, a middle name, and a combination of a title and at least one of the nickname, surname, given name and middle name.

4. The method of claim 1, wherein the relation feature includes at least one of
a rank gap feature, which represents a gap between two persons' ranks,
a familiar feature, which represents a familiarity degree between two persons,
a history appellation feature, which represents appellations that have been used between two persons, and
a context relation feature, which represents two persons' relation in the dialog.

5. The method of claim 4,
wherein the rank gap feature includes at least one of:
a feature of title gap, which represents a gap between titles of two persons, and
a feature of age gap, which represents a gap between ages of two persons;
wherein the familiar feature includes at least one of:
a feature of same working group, which represents whether two persons are in the same working group,
a feature of same major, which represents whether two persons are of the same major,
a feature of new employee, which represents whether a person is a new employee,
a feature of discussion frequency, which reflects a frequency of discussion between two persons, and
a feature of working station distance, which represents a distance between working stations of two persons;
wherein the context relation feature includes at least one of:
a feature of same meeting group, which represents whether two persons belong to the same meeting group,
a feature of co-joint meeting, which represents whether both of the two persons join a meeting,
a feature of seat class gap, which represents a gap between seat classes of two persons, wherein the seats are classified into at least two classes, one is primary seat and the other is secondary seat, and
a feature of seat distance, which represents a distance between seats of two persons.

6. The method of claim 4, wherein
the familiar feature and the history appellation feature are extracted from the external resources,
the rank gap feature is extracted from the external resources and/or the internal resources,
the context relation feature is extracted from the internal resources;
wherein, the external resources include text resources and image resources, the text resources include at least one of organization charts, email logs, email contacts, resumes and public documents, and the image resources at least include figures of working station; and
wherein, the internal resources include at least one of an attendee list, conference videos and conference photos.

7. The method of claim 6, wherein the history appellation feature is obtained by extracting an appellation between the candidate identifier and the at least one person name entity in history from the email logs.

8. The method of claim 6,
wherein the feature of title gap is obtained by
extracting title information of the candidate identifier and the at least one person name entity from the organization chart, and
calculating the title difference between the candidate identifier and the at least one person name entity based on the title information;
wherein the feature of age gap is obtained by
extracting age values of the candidate identifier and the at least one person name entity from an age field of the respective resume, and
calculating the age difference between the candidate identifier and the at least one person name entity based on the age values.

9. The method of claim 6,
wherein the feature of same working group is obtained by
extracting names of the working group for the candidate identifier and the at least one person name entity from the organization chart, and
calculating the feature of same working group based on the comparison of the names of the working group;
wherein the feature of same major is obtained by
extracting majors of the candidate identifier and the at least one person name entity from the organization chart, and
calculating the feature of same major based on the comparison of the majors;
wherein the feature of new employee is obtained by
calculating joining period of the candidate identifier according to the transition of the organization chart, and
calculating the feature of new employee based on the comparison of the joining period with a predetermined first threshold;
wherein the feature of discussion frequency is obtained by
counting a communication frequency between the candidate identifier and the at least one person name entity from the email logs, and
calculating the feature of discussion frequency based on the comparison of the communication frequency with a predetermined second threshold;
wherein the feature of working station distance is obtained by
obtaining working positions of the candidate identifier and the at least one person name entity from the figure of working station, and
calculating the feature of station distance based on the working positions.

10. The method of claim 6,
wherein the feature of same meeting group is obtained by
extracting the names of the meeting group for the candidate identifier and the at least one person name entity from the attendee list, and
calculating the feature of same meeting group based on the comparison of the names of the meeting group;
wherein the feature of co-joint meeting is obtained by
comparing the name of the candidate identifier with the attendee list, and
calculating the feature of co-joint meeting based on the comparison;
wherein the feature of seat class gap is obtained by
extracting seat classes of the candidate identifier and the at least one person name entity from the conference video or the conference photo, and
calculating the feature of seat class gap based on the seat classes;
wherein the feature of seat distance is obtained by
extracting seat positions of the candidate identifier and the at least one person name entity from the conference video or the conference photo, and
calculating the feature of seat distance based on the seat positions.

11. The method of claim 1, wherein the step of selecting an identifier from the group of candidate identifiers as the identifier of the mentioned person name includes:
calculating scores of the at least one relation feature for each of the candidate identifiers;
assigning a weight to the at least one relation feature,
calculating a confidence value for each of the candidate identifiers based on the calculated scores and the assigned weights, and
selecting an identifier from the group of candidate identifiers as the identifier of the mentioned person name based on the confidence values.

12. The method of claim 11, wherein
the weight is assigned according to scenarios of the dialog,
the scenarios of the dialog are extracted from context features of the dialog, and
the context features of the dialog include at least one of a title, a topic and a language style of the dialog, and dress style of attendees.

13. A method for managing meeting minutes, comprising:
identifying a mentioned person by using the method of claim 1; and
embedding information associated with the selected identifier into the mentioned person name in an output text.

14. A method for managing meeting minutes, comprising:
identifying a mentioned person by using the method of claim 1; and
embedding information associated with the selected identifier into the mentioned person name in an output text;
wherein the relation features include at least one of:
a feature of title gap, which represents a gap between titles of two persons,
a feature of same working group, which represents whether two persons are in the same working group, and
a history appellation feature, which represents appellations that have been used between two persons.

15. The method of claim 14, wherein
the feature of title gap is obtained by
extracting title information of the candidate identifier and the at least one person name entity from an organization chart, and
calculating the title difference between the candidate identifier and the at least one person name entity based on the title information;
the feature of same working group is obtained by
extracting names of the working group for the candidate identifier and the at least one person name entity from an organization chart, and
calculating the feature of same working group based on the comparison of the names of the working group;
the history appellation feature is obtained by
extracting an appellation between the candidate identifier and the at least one person name entity in history from email logs.

16. A method for managing a conference, comprising:
identifying a mentioned person by using the method of claim 1; and
displaying information associated with the selected identifier on a screen.

17. A method for managing a conference, comprising:
identifying a mentioned person by using the method of claim 1; and
displaying information associated with the selected identifier on a screen;
wherein the relation features include at least one of:
a feature of title gap, which represents a gap between titles of two persons,
a feature of same working group, which represents whether two persons are in the same working group,
a history appellation feature, which represents appellations that have been used between two persons,
a feature of seat class gap, which represents a gap between seat classes of two persons, and
a feature of seat distance, which represents a distance between seats of two persons.

18. The method of claim 17, wherein
the feature of title gap is obtained by
extracting title information of the candidate identifier and the at least one person name entity from an organization chart, and
calculating the title difference between the candidate identifier and the at least one person name entity based on the title information;
the feature of same working group is obtained by
extracting names of the working group for the candidate identifier and the at least one person name entity from an organization chart, and
calculating the feature of same working group based on the comparison of the names of the working group;
the history appellation feature is obtained by
extracting an appellation between the candidate identifier and the at least one person name entity in history from email logs;
the feature of seat class gap is obtained by
extracting seat classes of the candidate identifier and the at least one person name entity from a conference video or a conference photo, and
calculating the feature of seat class gap based on the seat classed, and
the feature of seat distance is obtained by
extracting seat positions of the candidate identifier and the at least one person name entity from a conference video or a conference photo, and
calculating the feature of seat distance based on the seat positions.

19. A method for assisting an instant message, comprising:
identifying a mentioned person by using the method of claim 1; and
embedding information associated with the selected identifier into the mentioned person name in the instant message.

20. A method for assisting an instant message, comprising:
identifying a mentioned person by using the method of claim 1; and
embedding information associated with the selected identifier into the mentioned person name in the instant message,
wherein the relation features include at least one of:
a feature of title gap, which represents a gap between titles of two persons,
a feature of age gap, which represents a gap between ages of two persons,
a feature of name category, which represents whether two persons are familiar with each other,
a feature of discussion frequency, which reflects a frequency of discussion between two persons, and
a history appellation feature, which represents appellations that have been used between two persons.

21. The method of claim 20, wherein
the feature of title gap is obtained by
extracting title information of the candidate identifier and the at least one person name entity from remark information of instant messages, and
calculating the title difference between the candidate identifier and the at least one person name entity based on the title information;
the feature of age gap is obtained by
extracting age values of the candidate identifier and the at least one person name entity from the remark information of instant messages, and
calculating the age difference between the candidate identifier and the at least one person name entity based on the age values;
the feature of name category is obtained by
extracting the name category of the candidate identifier from instant messages, and
calculating the feature of name category by comparing the extracted name category with the predetermined familiar name category;
the feature of discussion frequency is obtained by
counting a communication frequency between the candidate identifier and the at least one person name entity from instant messages, and
calculating the feature of discussion frequency based on the comparison of the communication frequency with a predetermined threshold;
the history appellation feature is obtained by
extracting an appellation between the candidate identifier and the at least one person name entity in history from instant messages.

22. An apparatus for identifying a mentioned person in a dialog, comprising:
unit for identifying at least one person name entity associated with a mentioned person name which is acquired from the dialog;
unit for acquiring a group of candidate identifiers associated with the mentioned person name;
unit for acquiring at least one relation feature for each of the candidate identifiers from internal resources and external resources, wherein the relation feature refers to the relation between the candidate identifier and the at least one person name entity; and
unit for selecting an identifier from the group of candidate identifiers as the identifier of the mentioned person name based on the at least one relation feature.

23. The apparatus of claim 22, wherein the relation feature includes at least one of
a rank gap feature, which represents a gap between two persons' ranks,
a familiar feature, which represents a familiarity degree between two persons,
a history appellation feature, which represents appellations that have been used between two persons, and
a context relation feature, which represents two persons' relation in the dialog.

24. The apparatus of claim 23,
wherein the rank gap feature includes at least one of:
a feature of title gap, which represents a gap between titles of two persons, and
a feature of age gap, which represents a gap between ages of two persons;
wherein the familiar feature includes at least one of:
a feature of same working group, which represents whether two persons are in the same working group,
a feature of same major, which represents whether two persons are of the same major,
a feature of new employee, which represents whether a person is a new employee,
a feature of discussion frequency, which reflects a frequency of discussion between two persons, and
a feature of working station distance, which represents a distance between working stations of two persons;
wherein the context relation feature includes at least one of:
a feature of same meeting group, which represents whether two persons belong to the same meeting group,
a feature of co-joint meeting, which represents whether both of the two persons join a meeting,
a feature of seat class gap, which represents a gap between seat classes of two persons, wherein the seats are classified into at least two classes, one is primary seat and the other is secondary seat, and
a feature of seat distance, which represents a distance between seats of two persons.

25. The apparatus of claim 23, wherein
the familiar feature and the history appellation feature are extracted from the external resources,
the rank gap feature is extracted from the external resources and/or the internal resources,
the context relation feature is extracted from the internal resources;
wherein, the external resources include text resources and image resources, the text resources include at least one of organization charts, email logs, email contacts, resumes and public documents, and the image resources at least include figures of working station; and
wherein, the internal resources include at least one of an attendee list, conference videos and conference photos.

26. The apparatus of claim 22, wherein the unit for selecting an identifier from the group of candidate identifiers as the identifier of the mentioned person name further comprising:
unit for calculating scores of the at least one relation feature for each of the candidate identifiers;
unit for assigning a weight to the at least one relation feature,
unit for calculating a confidence value for each of the candidate identifiers based on the calculated scores and the assigned weights, and
unit for selecting an identifier from the group of candidate identifiers as the identifier of the mentioned person name based on the confidence values.

27. An apparatus for managing meeting minutes, comprising:
unit for identifying a mentioned person by using the apparatus of claim 22; and
unit for embedding information associated with the selected identifier into the mentioned person name in an output text.

28. An apparatus for managing meeting minute, comprising:
unit for identifying a mentioned person by using the apparatus of claim 22; and
unit for embedding information associated with the selected identifier into the mentioned person name in an output text,
wherein the relation features include at least one of:
a feature of title gap, which represents a gap between titles of two persons,
a feature of same working group, which represents whether two persons are in the same working group, and
a history appellation feature, which represents appellations that have been used between two persons.

29. An apparatus for managing a conference, comprising:
unit for identifying a mentioned person by using the apparatus of claim 22; and
unit for displaying information associated with the selected identifier on a screen.

30. An apparatus for managing a conference, comprising:
unit for identifying a mentioned person by using the apparatus of claim 22; and
unit for displaying information associated with the selected identifier on a screen,
wherein the relation features include at least one of:
a feature of title gap, which represents a gap between titles of two persons,
a feature of same working group, which represents whether two persons are in the same working group,
a history appellation feature, which represents appellations that have been used between two persons,
a feature of seat class gap, which represents a gap between seat classes of two persons, and
a feature of seat distance, which represents a distance between seats of two persons.

31. An apparatus for assisting an instant message, comprising:
unit for identifying a mentioned person by using the apparatus of claim 22; and
unit for embedding information associated with the selected identifier into the mentioned person name in the instant message.

32. An apparatus for assisting an instant message, comprising:
unit for identifying a mentioned person by using the apparatus of claim 22; and
unit for embedding information associated with the selected identifier into the mentioned person name in the instant message,
wherein the relation features include at least one of:
a feature of title gap, which represents a gap between titles of two persons,
a feature of age gap, which represents a gap between ages of two persons,
a feature of name category, which represents whether two persons are familiar with each other,
a feature of discussion frequency, which reflects a frequency of discussion between two persons, and
a history appellation feature, which represents appellations that have been used between two persons.
